(19) United States
(12) Patent Application Publication
(10) Pub. No.: US 2021/0165144 A1
(43) Pub. Date: Jun. 3, 2021

(54) IMAGE PICKUP APPARATUS AND IMAGE PROCESSING APPARATUS

(71) Applicant: Sharp Kabushiki Kaisha, Sakai City, Osaka (JP)

(72) Inventors: Shinobu YAMAZAKI, Sakai City (JP); Takashi NAKANO, Sakai City (JP); Yukio TAMAI, Sakai City (JP); Daisuke HONDA, Sakai City (JP)

(21) Appl. No.: 16/061,668

(22) PCT Filed: Oct. 26, 2017
(86) PCT No.: PCT/JP2017/038773

§ 371 Date: Jun. 13, 2018

(30) Foreign Application Priority Data
Jan. 31, 2017 (JP) 2017-015941

(51) Int. Cl. G02B 5/20; H04N 5/33; G01N 21/21; H04N 5/359

(52) U.S. Cl. CPC G02B 5/208; H04N 5/359; G01N 21/21; H04N 5/33

(57) ABSTRACT

An influence of a reflected image included in an infrared light image is reduced. An image pickup unit (20) includes an image pickup element (21) including an infrared light image-image pickup region (21a) and a visible light image-image pickup region (21b) and a polarizing filter (25) in which a plurality of polarizing units including a plurality of polarizing elements (25a to 25d) having principal axes different from each other are associated with a plurality of pixels forming the infrared light image-image pickup region and are arranged two-dimensionally.

### TECHNICAL FIELD

The disclosure below relates to an image pickup apparatus or the like configured to capture an image.

### BACKGROUND ART

In recent years, there has been a growing user's recognition of security in information processing devices such as mobile phones and tablet Personal Computers (PC). For this reason, various authentication technologies have been developed. In recent years, an authentication technology having an extremely high degree of reliability, such as an iris authentication technology, has been developed, and mobile phones equipped with the iris authentication technology are commercially available.

PTL 1 discloses an example of a personal authentication device equipped with such an iris authentication technology. PTL 1 discloses a compact personal authentication device capable of performing authentication with a visible light image (for example, face authentication) and authentication with an infrared light image (for example, iris authentication). The personal authentication device includes a single image pickup unit that detects visible light and infrared light and respectively outputs them as a visible light image and an infrared light image, and performs personal authentication by using the visible light image and the infrared light image. Specifically, the image pickup unit includes a light-receiving unit that receives infrared rays (IR) in addition to red (R), green (G), and blue (B).

### CITATION LIST

### Patent Literature

PTL 1: JP 2005-339425 A (published on Dec. 8, 2005)

### SUMMARY OF INVENTION

### Technical Problem

Herein, light forming an image as a target of image processing (for example, an image of an iris) in a captured infrared light image is mostly formed of a diffused reflected component in general. On the other hand, light forming an image as noise that needs to be removed in image processing (reflected image that needs to be excluded from processing, for example, an image reflected in an iris) is mostly formed of a specularly reflected component. Therefore, the specularly reflected component appropriately needs to be removed from the light forming an infrared light image in order to accurately perform authentication with the infrared light image.

However, PTL 1 does not disclose removal of a specularly reflected component at all. Thus, when a reflected image is included in an infrared light image, the personal authentication device in PTL 1 may specify even the reflected image as a part of an image of a process target and perform false authentication.

An object of one aspect of the present disclosure is to achieve an image pickup apparatus capable of reducing, when image processing is performed on a captured infrared light image, an influence of a reflected image other than an image of a process target included in the infrared light image.

### Solution to Problem

To solve the above-described problem, an image pickup apparatus according to one aspect of the present disclosure includes an image pickup element configured to capture an image by a plurality of pixels arranged two-dimensionally. The image pickup element includes a visible light image-image pickup region configured to capture a visible light image by receiving visible light and an infrared light image-image pickup region configured to capture an infrared light image by receiving infrared light. The image pickup apparatus further includes a polarizing filter that includes a plurality of polarizing units including a plurality of polarizing elements having principal axes different from each other, the plurality of polarizing units being associated with the plurality of pixels forming the infrared light image-image pickup region and being arranged two-dimensionally.

### Advantageous Effects of Invention

According to one aspect of the present disclosure, when image processing is performed on a captured infrared light image, an influence of a reflected image other than an image of a process target included in the infrared light image can be reduced.

### BRIEF DESCRIPTION OF DRAWINGS

FIGS. 1A to 1C are diagrams illustrating an example of a configuration of an image pickup unit according to a first embodiment on an infrared light image-image pickup region side. FIG. 1A is a diagram schematically illustrating a configuration of an image pickup element. FIG. 1B is a cross-sectional view schematically illustrating a configuration of the infrared light image-image pickup region. FIG. 1C is a plan view schematically illustrating a configuration of a polarizing filter.

FIGS. 2A to 2C are diagrams illustrating an example of a configuration of a mobile information terminal according to the first embodiment. FIG. 2A illustrates an example of an external appearance of the mobile information terminal. FIG. 2B illustrates an example of an external appearance of an image pickup unit provided in the mobile information terminal. FIG. 2C illustrates an example of an image captured by the image pickup unit.

FIG. 3 is a diagram for describing iris authentication.

FIGS. 4A to 4C are diagrams illustrating an example of a configuration of the image pickup unit according to the first embodiment on a visible light image-image pickup region side. FIG. 4A is a diagram schematically illustrating a configuration of the image pickup element. FIG. 4B is a cross-sectional view schematically illustrating a configuration of the visible light image-image pickup region. FIG. 4C is a plan view schematically illustrating a configuration of a color filter.

FIG. 5 is a functional block diagram illustrating a configuration of the mobile information terminal according to the first embodiment.

FIG. 6 is a flowchart illustrating iris authentication processing by a controller according to the first embodiment.

FIG. 7A is a diagram illustrating a configuration of a polarizing filter according to a modified example of the first embodiment. FIG. 7B is a diagram illustrating a configuration of a polarizing filter according to another modified example of the first embodiment.

FIGS. 8A and 8B are diagrams illustrating an example of a configuration of a mobile information terminal according to a second embodiment. FIG. 8A illustrates an example of an external appearance of the mobile information terminal. FIG. 8B is a plan view schematically illustrating a configuration of a polarizing filter provided in the mobile information terminal.

FIG. 9 is a functional block diagram illustrating a configuration of the mobile information terminal according to the second embodiment.

FIG. 10 is a cross-sectional view schematically illustrating a configuration of an image pickup unit according to the second embodiment.

FIG. 11 is a flowchart illustrating iris authentication processing by a controller according to the second embodiment.

FIG. 12 is a functional block diagram illustrating a configuration of a mobile information terminal according to a third embodiment.

FIGS. 13A and 13B are diagrams for describing a periodic change in an output value of a pixel. FIG. 13A is a diagram illustrating an output value of a pixel when a piece of paper with an image of a person printed is continuously captured. FIG. 13B is a diagram illustrating an output value of a pixel when an actual person is continuously captured.

FIG. 14 is a flowchart illustrating iris authentication processing by a controller according to the third embodiment.

### DESCRIPTION OF EMBODIMENTS

### First Embodiment

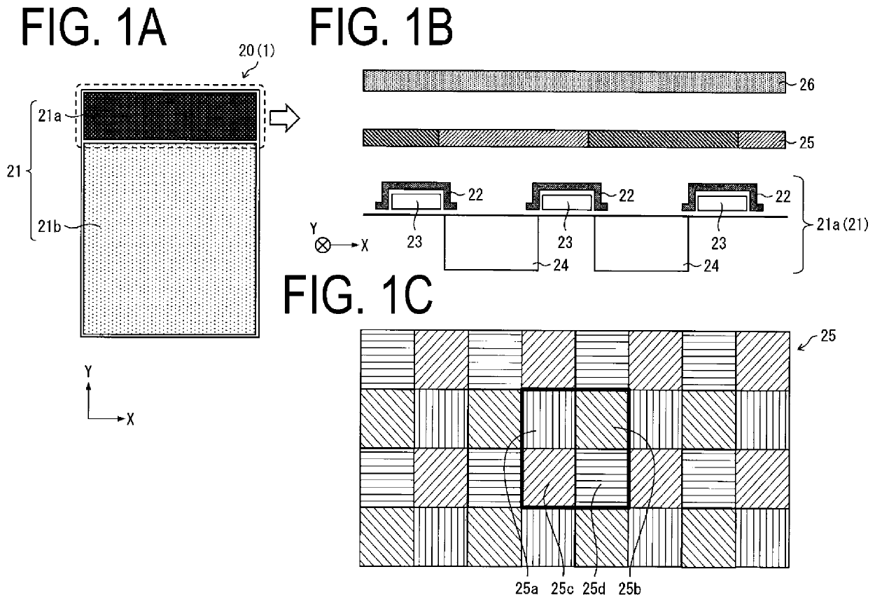

A first embodiment of the present disclosure will be described below in detail with reference to FIGS. 1A to 7B.

### Configuration of Mobile Information Terminal 1

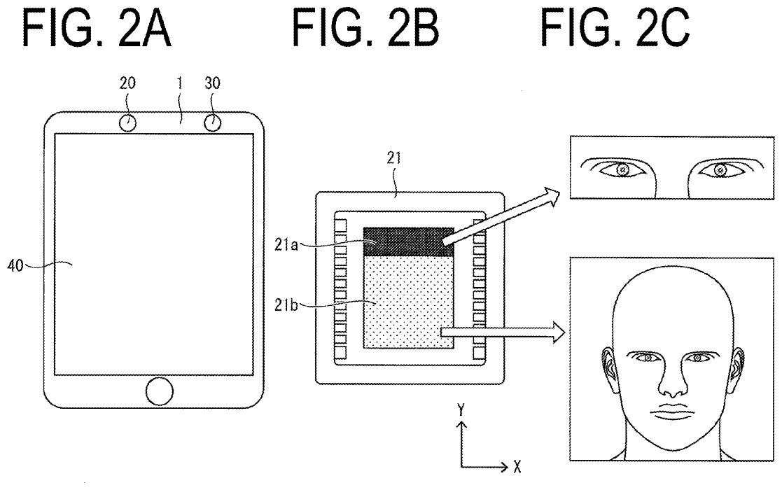

First, a configuration of a mobile information terminal 1 will be described by using FIGS. 2A and 2C. FIGS. 2A to 2C are diagrams illustrating an example of a configuration of the mobile information terminal 1. FIG. 2A illustrates an example of an external appearance of the mobile information terminal 1. FIG. 2B illustrates an example of an external appearance of an image pickup unit 20 provided in the mobile information terminal 1. FIG. 2C illustrates an example of an image captured by the image pickup unit 20.

The mobile information terminal 1 according to the present embodiment has an image pickup function of capturing an image including an object by acquiring visible light and infrared light reflected by the object and an image processing function of performing image processing on the captured image.

The mobile information terminal 1 according to the present embodiment further has an authentication function of verifying the object included in the captured image in response to the result of the image processing. In particular, the mobile information terminal 1 is equipped with a function of performing iris authentication by performing image processing on an infrared light image generated by receiving infrared light reflected by eyeballs of a user (human) as an object. In this case, the mobile information terminal 1 is a terminal capable of separating, in an infrared light image including the captured eyeballs of the user, a diffused reflected component from a specularly reflected component, which components are contained in the infrared light reflected by the eyeballs, and performing iris authentication of the user by using the infrared light image having the components separated.

As illustrated in FIG. 2A, the mobile information terminal 1 includes the image pickup unit 20 (image pickup apparatus), an infrared light source 30, and a display unit 40. The image pickup unit 20 captures an image including an object on the basis of a user operation. The infrared light source 30 emits infrared light (particularly, near infrared light) when, for example, the image pickup unit 20 receives infrared light to capture an infrared light image. The display unit 40 displays various images such as an image captured by the image pickup unit 20.

### Configuration of Image Pickup Unit 20

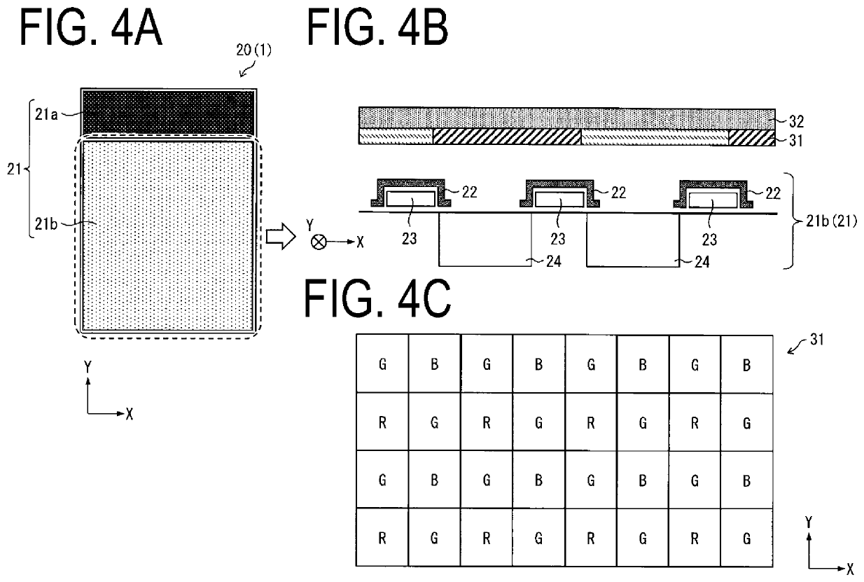

Next, the image pickup unit 20 will be described by using FIGS. 1A to 1C, 2A to 2C, and 4A to 4C. FIGS. 1A to 1C are diagrams illustrating an example of a configuration of the image pickup unit 20 on an infrared light image-image pickup region 21a side. FIG. 1A is a diagram schematically illustrating a configuration of an image pickup element 21. FIG. 1B is a cross-sectional view schematically illustrating a configuration of the infrared light image-image pickup region 21a. FIG. 1C is a plan view schematically illustrating a configuration of a polarizing filter 25. FIGS. 4A to 4C are diagrams illustrating an example of a configuration of the image pickup unit 20 on a visible light image-image pickup region 21b side. FIG. 4A is a diagram schematically illustrating a configuration of the image pickup element 21. FIG. 4B is a cross-sectional view schematically illustrating a configuration of the visible light image-image pickup region 21b. FIG. 4C is a plan view schematically illustrating a configuration of a color filter 31.

### Image Pickup Element 21

The image pickup unit 20 includes the image pickup element 21 illustrated in FIG. 2B. The image pickup element 21 captures an image by a plurality of pixels arranged two-dimensionally. Examples of the image pickup element 21 include a Charge Coupled Device (CCD) and a Complementary Metal Oxide Semiconductor (CMOS). The present embodiment will be described by taking an example in which the image pickup element 21 is formed of a CCD.

Specifically, the image pickup element 21 includes the infrared light image-image pickup region 21a configured to capture an infrared light image by receiving infrared light and the visible light image-image pickup region 21b configured to capture a visible light image by receiving visible light. In other words, the infrared light image-image pickup region 21a and the visible light image-image pickup region 21b are formed in one image pickup element 21. Thus, the image pickup unit 20 that captures an infrared light image and a visible light image can be reduced in size by using the image pickup element 21.

In the present embodiment, the infrared light image-image pickup region 21a is a region used in an authentication mode of capturing an infrared light image with eyeballs of a user as an object as illustrated in FIG. 2C when iris authentication is performed. A pupil of humans has various colors. In a case of a visible light image, an image of an iris may be unclear due to the color. On the other hand, in a case of an infrared light image, a clear iris image can be acquired because an image of a pupil from which a component of the color is removed can be acquired. Thus, the infrared light image is acquired in the authentication mode of the present embodiment.

The visible light image-image pickup region 21b is a region used in a normal mode of capturing a visible light image of an object. In the present embodiment, a visible light image captured by the visible light image-image pickup region 21b is not used for authentication or the like. As illustrated in FIG. 2C, for example, the visible light image-image pickup region 21b acquires a visible light image including the whole face of a user as an object.

In this way, the mobile information terminal 1 equipped with the image pickup element 21 can capture an infrared light image used for the iris authentication and a visible light image not used for the authentication by the common image pickup unit 20. Thus, the mobile information terminal 1 includes the image pickup unit 20 closer to the display unit 40 as illustrated in FIG. 2A, so that the image pickup unit 20 can capture an infrared light image without providing an image pickup unit (infrared light camera) for the iris authentication. In other words, the mobile information terminal 1 capable of capturing an infrared light image and a visible light image can be reduced in size by reducing the size of the image pickup unit 20 as mentioned above.

The image pickup element 21 may at least include the infrared light image-image pickup region 21a and the visible light image-image pickup region 21b. In the present embodiment, an image pickup region of the image pickup element 21 is divided into the infrared light image-image pickup region 21a and the visible light image-image pickup region 21b along a long-side direction (Y-axis direction) of the mobile information terminal 1 (specifically, the image pickup element 21). When the iris authentication is performed, a user generally holds the mobile information terminal 1 such that the long-side direction of the mobile information terminal 1 crosses a line connecting two eyes of the user and captures the eyes of the user. The image pickup region of the image pickup element 21 is preferably divided into the infrared light image-image pickup region 21a and the visible light image-image pickup region 21b along the long-side direction in consideration of a general use manner during the iris authentication.

Note that in the image pickup element 21 illustrated in FIG. 2B, the infrared light image-image pickup region 21a and the visible light image-image pickup region 21b are respectively disposed on the top side and the bottom side with +Y-axis direction as the top, but they may be disposed in the opposite positions. Furthermore, the image pickup region of the image pickup element 21 may be divided into the infrared light image-image pickup region 21a and the visible light image-image pickup region 21b along a short-side direction (X-axis direction) of the mobile information terminal 1. Such division is effective when the mobile information terminal 1 is held such that the long-side direction of the mobile information terminal 1 is substantially parallel with a line connecting two eyes of a user and the eyes of the user are captured. However, as long as eyes of a user can be captured in the iris authentication, the infrared light image-image pickup region 21a and the visible light image-image pickup region 21b may be disposed in any manner in the image pickup element 21.

The infrared light image-image pickup region 21a and the visible light image-image pickup region 21b as respectively illustrated in FIGS. 1B and 4B include transfer lines 22, 23 and a photodiode 24.

The transfer lines 22, 23 respectively extend in the X-axis direction and the Y-axis direction in surfaces of the infrared light image-image pickup region 21a and the visible light image-image pickup region 21b and transmit an output from the photodiode 24 to a controller 10 (described later). In this way, an infrared light image captured with the infrared light image-image pickup region 21a and a visible light image captured with the visible light image-image pickup region 21b can be transmitted to the controller 10 that performs image processing.

The photodiode 24 receives infrared light in the infrared light image-image pickup region 21a and receives visible light in the visible light image-image pickup region 21b. Each photodiode 24 forms a pixel of the image pickup element 21. In other words, the image pickup element 21 has a configuration in which the plurality of photodiodes 24 are arranged two-dimensionally as the plurality of pixels.

### Configuration on Infrared Light Image-Image Pickup Region 21a Side

The image pickup unit 20 includes the polarizing filter (integrated polarizer) 25 and a visible light blocking filter 26 as illustrated in FIG. 1B on the infrared light image-image pickup region 21a side of the image pickup element 21 illustrated in FIG. 1A. As illustrated in FIG. 1B, the visible light blocking filter 26, the polarizing filter 25, and the image pickup element 21 are layered in this order when seen from a direction in which light enters the image pickup unit 20.

The polarizing filter 25 includes a plurality of polarizing units that include a plurality of polarizing elements having principal axes, which directions are different from each other, and that are associated with the plurality of pixels forming the infrared light image-image pickup region 21a and are arranged two-dimensionally. In the present embodiment, the polarizing filter 25 includes one polarizing element arranged so as to correspond to one pixel of the infrared light image-image pickup region 21a. Also, in the present embodiment, as illustrated in FIG. 1C, four adjacent polarizing elements 25a to 25d corresponding to four adjacent respective pixels form one polarizing unit. Specifically, the four polarizing elements 25a to 25d forming one polarizing unit respectively have a polarizing angle of 0°, 45°, 90°, and 135°.

The polarizing filter 25 is formed directly on the plurality of pixels (namely, the infrared light image-image pickup region 21a). The polarizing filter 25 may be able to be formed in such a manner. Examples of the polarizing filter 25 include a filter that includes a wire grid made of metal such as aluminum (Al) and a filter that includes a photonic crystal including layered materials having refractive indexes different from each other.

Note that a pixel group (four pixels in the present embodiment) associated with one polarizing unit may be referred to as one pixel unit in some cases.

The visible light blocking filter 26 is provided in the infrared light image-image pickup region 21a and blocks visible light toward the infrared light image-image pickup region 21a. A color of an iris varies among people. Thus, when an infrared light image contains a visible light component, an image of the iris may be unclear. An unclear image of an iris can be suppressed by providing the visible light blocking filter 26 in the infrared light image-image pickup region 21a, and degradation in image quality of an infrared light image can thus be suppressed.

A relative position of the visible light blocking filter 26 to the infrared light image-image pickup region 21a is fixed. In a case of a configuration causing a visible light blocking filter to move with respect to an image pickup element depending on an image pickup manner, a movement mechanism for moving the visible light blocking filter generally needs to be provided. However, the image pickup unit 20 does not need to include such a movement mechanism. Thus, the image pickup unit 20 can be reduced in size. Furthermore, because of no dust caused by operating the movement mechanism, the possibility that foreign matter is reflected in an infrared light image captured with the infrared light image-image pickup region 21a is reduced.

### With Regard to Iris Authentication

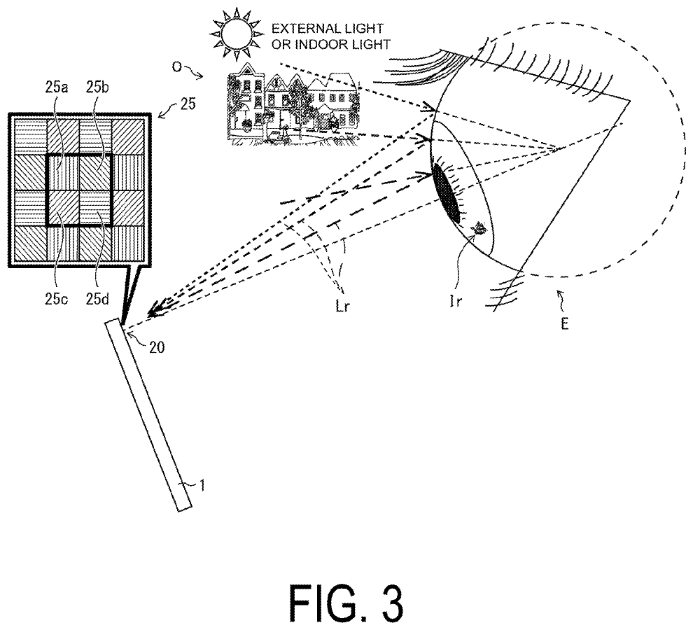

Herein, the iris authentication will be described by using FIG. 3. FIG. 3 is a diagram for describing the iris authentication. Note that FIG. 3 is described on the assumption that an eyeball E of a user is captured with infrared light included in external light (sunlight) or indoor light in the above-described authentication mode.

As illustrated in FIG. 3, when the eyeball E of the user is irradiated with external light or indoor light, the light is reflected by the eyeball E and an infrared light component thereof then enters the infrared light image-image pickup region 21a of the image pickup unit 20.

The eyeball E of the user is irradiated with external light or indoor light, and the infrared light image-image pickup region 21a acquires an infrared light component of a diffused reflected light Lr obtained from the external light or the indoor light being diffused and reflected by an iris. Thus, the infrared light image-image pickup region 21a acquires an infrared light image including an image of the iris of the user. The mobile information terminal 1 then performs user authentication by analyzing the image of the iris. On the other hand, when ambient light around the authenticated user is bright and an object O as a source of a reflected image is present, a reflected image Ir is formed on the eyeball E (more specifically, a surface of a cornea). The reflected image Ir occurs when the object O is irradiated with ambient light and the reflected light from the object O is further specularly reflected by the eyeball E (more specifically, the surface of the cornea). The infrared light image-image pickup region 21a then extracts an infrared light component from the diffused reflected light Lr from the iris and from the specularly reflected light forming the reflected image Ir, and thus acquires an infrared light image.

Therefore, when the polarizing filter 25 is not provided in the infrared light image-image pickup region 21a and thus the mobile information terminal 1 does not have a function of removing the reflected image Ir from the infrared light image including the acquired image of the iris and the reflected image Ir, the reflected image Ir affects an image analysis of the iris. As a result, the mobile information terminal 1 may not enable accurate iris authentication.

Since intense reflection occurs in the eyeball E of the user under irradiation of sunlight, accurate iris authentication is particularly difficult at the outdoors. An influence of sunlight on the iris authentication can be reduced by irradiating the eyeball E of the user with light having higher intensity than intensity of sunlight. However, when the eyeball E or skin is irradiated with such light having high intensity, a state of the eyeball E or the skin may deteriorate. There is also a problem that power consumption increases.

Herein, light forming an image used in image processing (herein, the diffused reflected light Lr indicating the iris used in the authentication processing) is mostly formed of a diffused reflected component in general. In the present embodiment, the light is processed as an indicator indicating surface information about a surface of the eyeball E (specifically, the iris) needed in the authentication processing. Since the iris has a fine and complicated structure, the diffused reflected light Lr forming the image of the iris is rarely polarized. On the other hand, light forming an image as noise that needs to be removed in the image processing (herein, light forming the reflected image Ir of the object O that adversely affects the authentication processing) is mostly formed of a specularly reflected component. Specularly reflected light has been known to have a high degree of polarization, which may be changed by an incident angle.

In the mobile information terminal 1 of the present embodiment, as mentioned above, the image pickup unit 20 includes the polarizing filter 25 provided so as to correspond to the infrared light image-image pickup region 21a. Thus, in the mobile information terminal 1, the controller 10 described later can perform image processing on an infrared light image acquired by the infrared light image-image pickup region 21a via the polarizing filter 25. Then, the mobile information terminal 1 can acquire a clear image of an iris in which an influence of the reflected image Ir in an image analysis of the iris is reduced without irradiating the eyeball E with light having high intensity as described above by the image processing, and can perform accurate iris authentication.

In other words, the image pickup unit 20 includes the polarizing filter 25 as described above and can thus reduce an influence of the reflected image Ir other than an image of a process target (an image of an iris in the present embodiment) when image processing is performed on a captured infrared light image.

As mentioned above, the polarizing filter 25 includes the plurality of polarizing units including the plurality of polarizing elements 25a to 25d having the principal axes, which directions are different from each other. Thus, the polarizing filter 25 can handle specularly reflected light forming the reflected image Ir and having different polarization directions at places reflected on the eyeball E. The handling can reduce an influence of the reflected image Ir in the above-described image processing by the controller 10.

### Configuration on Visible Light Image-Image Pickup Region 21b Side

The image pickup unit 20 includes the color filter 31 and an infrared light blocking filter 32 as illustrated in FIG. 4B on the visible light image-image pickup region 21b side of the image pickup element 21 illustrated in FIG. 4A. As illustrated in FIG. 4A, the infrared light blocking filter 32, the color filter 31, and the image pickup element 21 are layered in this order when seen from the direction in which light enters the image pickup unit 20.

The color filter 31 is formed of a filter having three primary colors (RGB) different for every sub-pixel of the visible light image-image pickup region 21b in order to achieve multicolor display of a visible light image captured with the visible light image-image pickup region 21b. In the color filter 31, filters corresponding to respective three primary colors are arranged two-dimensionally as illustrated in FIG. 4C, for example. The color filter 31 is formed of, for example, an organic material.

The infrared light blocking filter 32 is provided in the visible light image-image pickup region 21b and blocks infrared light toward the visible light image-image pickup region 21b. The color filter generally allows infrared light to pass therethrough. Thus, when a visible light image contains an infrared light component, image quality of the visible light image may deteriorate. The degradation in the image quality of the visible light image can be suppressed by providing the infrared light blocking filter 32 in the visible light image-image pickup region 21b.

In the present embodiment, the infrared light blocking filter 32 is formed of the same organic material as that for the color filter 31. Thus, the color filter 31 and the infrared light blocking filter 32 can be manufactured in the same manufacturing step. Without consideration of this point, the infrared light blocking filter 32 may be formed of other material capable of blocking infrared light.

A relative position of the infrared light blocking filter 32 to the visible light image-image pickup region 21b is fixed. In a case of a configuration causing an infrared light blocking filter to move with respect to an image pickup element depending on an image pickup manner (for example, the invention according to PTL 1), a movement mechanism for moving the infrared light blocking filter generally needs to be provided. However, the image pickup unit 20 does not need to include such a movement mechanism. Thus, the image pickup unit 20 can be reduced in size. Furthermore, because of no dust caused by operating the movement mechanism, the possibility that foreign matter is reflected in a visible light image captured with the visible light image-image pickup region 21b is reduced.

### Configuration of Controller 10

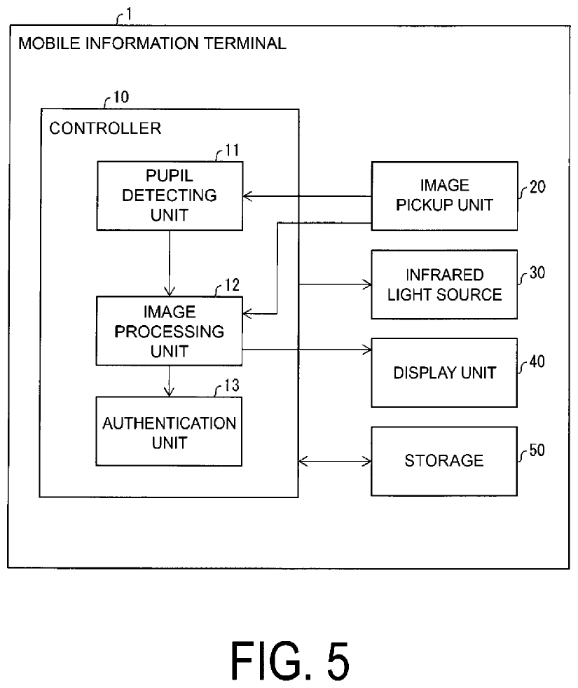

Next, a configuration of the controller 10 provided in the mobile information terminal 1 will be described by using FIG. 5. FIG. 5 is a functional block diagram illustrating a configuration of the mobile information terminal 1. As illustrated in FIG. 5, the mobile information terminal 1 includes the controller 10 (image processing apparatus), the image pickup unit 20, the infrared light source 30, the display unit 40, and a storage 50.

The controller 10 includes a pupil detecting unit 11, an image processing unit 12, and an authentication unit 13. Each of the units provided in the controller 10 will be described later. The image pickup unit 20, the infrared light source 30, and the display unit 40 are as mentioned above. The storage 50 is a storage medium that stores information needed to control the controller 10 and is, for example, a flash memory or the like.

The pupil detecting unit 11 acquires an infrared light image captured by the image pickup unit 20 with the infrared light image-image pickup region 21a and specifies a region corresponding to a pupil of a user included in the infrared light image. The processing in the pupil detecting unit 11 is well known in the field of authentication by an image of an iris, for example, so that the description thereof will be omitted from the present specification.

The image processing unit 12 performs image processing on an infrared light image captured by the image pickup unit 20 (specifically, with the infrared light image-image pickup region 21a). Specifically, the image processing unit 12 performs the image processing on the infrared light image captured with the infrared light image-image pickup region 21a so as to reduce a specularly reflected component contained in infrared light received by the infrared light image-image pickup region 21a. In the present embodiment, the image processing unit 12 determines an output value of a pixel having the lowest received-light intensity of received infrared light (namely, a result obtained through the image processing in the present example) of a plurality of pixels included in each pixel unit in the infrared light image-image pickup region 21a as an output value of the pixel unit. Herein, the output value indicates various values indicating an infrared light image, such as received-light intensity of infrared light.

As mentioned above, the infrared light forming the reflected image Ir has a high degree of polarization. Thus, intensity of the infrared light removed by the polarizing filter 25 varies depending on an angle of polarization of the polarizing elements 25a to 25d. In a pixel having the lowest received-light intensity of received infrared light of the pixels included in the pixel unit, the infrared light forming the reflected image Ir is conceivably removed best by the polarizing element corresponding to the pixel. Therefore, the image processing unit 12 determines an output value as described above and can thus acquire an infrared light image in which an influence of the reflected image Ir is reduced.

The image processing unit 12 also performs the image processing on a visible light image captured by the image pickup unit 20 (specifically, with the visible light image-image pickup region 21b). In the present embodiment, the visible light image is not used for authentication processing. Thus, the image processing unit 12 performs prescribed image processing on the visible light image, and the display unit 40 displays the visible light image. The image processing unit 12 may also store the visible light image in the storage 50. Note that the image processing unit 12 may perform prescribed image processing on an infrared light image captured with the infrared light image-image pickup region 21a, and the display unit 40 may display the infrared light image.

The authentication unit 13 performs user authentication by using an output value of each pixel unit processed by the image processing unit 12. In other words, since the authentication unit 13 performs the iris authentication by using the infrared light image from which the reflected image Ir is removed best, the authentication unit 13 can perform the authentication with high accuracy. The authentication by an iris in the authentication unit 13 is a well-known technology, so that the description thereof will be omitted from the present specification.

### Processing of Controller 10

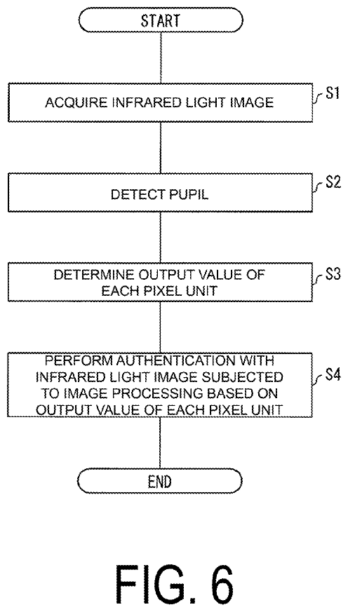

FIG. 6 is a flowchart illustrating iris authentication processing by the controller 10. Herein, iris authentication processing when an authentication mode is set in the mobile information terminal 1 will be described. In the iris authentication processing by the controller 10, first, the pupil detecting unit 11 acquires an infrared light image captured with the infrared light image-image pickup region 21a (S1), and then detects a pupil of a user included in the infrared light image (S2). Next, the image processing unit 12 determines an output value of each pixel unit as mentioned above (S3). Subsequently, the authentication unit 13 performs user authentication on the basis of the output value of each pixel unit (S4).

### MODIFIED EXAMPLE

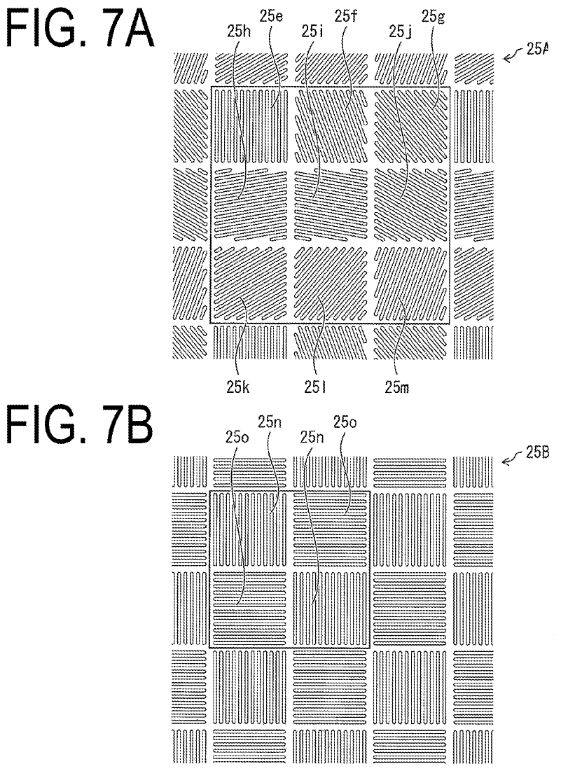

FIG. 7A is a diagram illustrating a configuration of a polarizing filter 25A according to a modified example of the present embodiment. The polarizing filter 25A is a filter that can substitute for the above-mentioned polarizing filter 25. As illustrated in FIG. 7A, nine adjacent polarizing elements 25e to 25m corresponding to nine adjacent respective pixels form one polarizing unit in the polarizing filter 25A. Specifically, the nine polarizing elements 25e to 25m forming one polarizing unit respectively have a polarizing angle of 0°, 20°, 40°, 60°, 80°, 100°, 120°, 140°, and 160°.

In this way, the number of polarizing elements included in one polarizing unit may be four or nine, and may be any other number. The more number of angles of the polarizing elements included in one polarizing unit allows a component of the reflected image Ir contained in received infrared light to be removed more accurately. However, one pixel unit is associated with one polarizing unit, so that one output value is output from one pixel unit as mentioned above. Thus, the more number of pixels for one polarizing unit reduces a resolution of an infrared light image after the processing performed by the image processing unit 12. Therefore, the number of polarizing elements included in one polarizing unit needs to be set in consideration of the accuracy of removing the component of the reflected image Ir and the resolution of the infrared light image used for the authentication.

FIG. 7B is a diagram illustrating a configuration of a polarizing filter 25B according to another modified example of the present embodiment. The polarizing filter 25B is also a filter that can substitute for the above-mentioned polarizing filter 25. As illustrated in FIG. 7B, two pairs of adjacent polarizing elements 25n and 25o corresponding to four adjacent respective pixels form one polarizing unit in the polarizing filter 25B. Specifically, the polarizing elements 25n and 25o respectively have a polarizing angle of 0° and 90°. In this way, one polarizing unit may include a plurality of polarizing elements having the same polarizing angle.

Every one of the above-mentioned polarizing elements 25a to 25o is associated with one pixel. However, one polarizing element may be associated with a plurality of pixels. Note that the more number of pixels for one polarizing element (that is to say, the more number of pixels for one polarizing unit) reduces a resolution of an infrared light image after the processing performed by the image processing unit 12 for the same reason described above. Therefore, the number of pixels associated with one polarizing element needs to be set in consideration of the accuracy of removing the component of the reflected image Ir, the resolution of the infrared light image used for the authentication, and the size of an individual pixel in the infrared light image.

### Others

The object according to one aspect of the present disclosure is not limited to an eyeball, and may be any object with the possibility that reflection occurs. As a specific embodiment that needs to reduce an influence of a reflected image included in an infrared light image, the iris authentication is described above as an example. In addition, the image processing in the image pickup unit 20 and the controller 10 according to one aspect of the present disclosure is widely applicable to a technology that needs to reduce an influence of a reflected image.

The mobile information terminal 1 is described by taking the mobile information terminal 1 that integrally includes the controller 10, the image pickup unit 20, the infrared light source 30, and the display unit 40 as an example, but these members do not need to be integrally formed.

### Second Embodiment

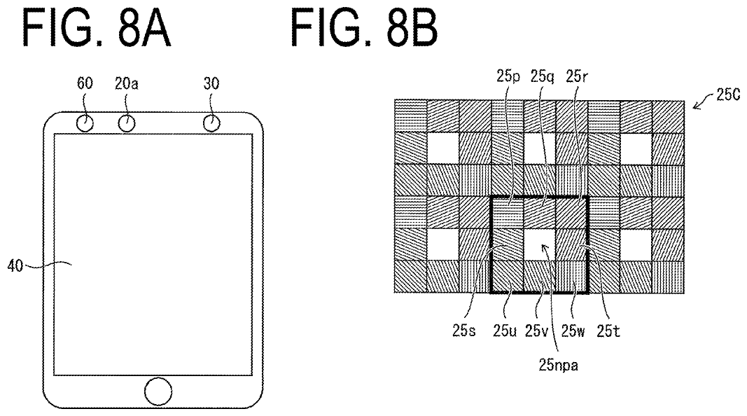

Another embodiment of the present disclosure will be described in the following with reference to FIGS. 8A to FIG. 11. Note that, for convenience of a description, components illustrated in respective embodiments are designated by the same reference numerals as those having the same function, and the descriptions of these components will be omitted.

### Configuration of Mobile Information Terminal 1a

FIGS. 8A and 8B are diagrams illustrating an example of a configuration of a mobile information terminal 1a according to the present embodiment. FIG. 8A illustrates an example of an external appearance of the mobile information terminal 1a. FIG. 8B is a plan view schematically illustrating a configuration of a polarizing filter 25C provided in the mobile information terminal 1a.

As illustrated in FIG. 8A, the mobile information terminal 1a is different from the mobile information terminal 1 in that the mobile information terminal 1a includes an illumination sensor 60 (illumination detecting unit) that detects illumination around the mobile information terminal 1a and an image pickup unit 20a instead of the image pickup unit 20.

### Configuration of Image Pickup Unit 20a

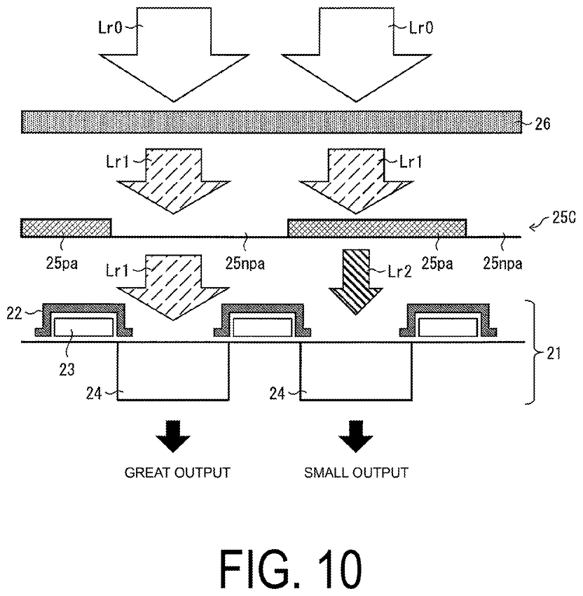

The image pickup unit 20a (image pickup apparatus) includes the polarizing filter 25C instead of the polarizing filter 25 in an infrared light image-image pickup region 21a. The polarizing filter 25C includes a polarization region 25pa (see FIG. 10) including eight respective polarizing elements 25p, 25q, 25r, 25s, 25t, 25u, 25v, and 25w and a non-polarization region 25npa including no polarizing element. In the polarizing filter 25C, the polarization region 25pa and the non-polarization region 25npa form one polarizing unit. The polarizing elements 25p to 25w respectively have a polarizing angle of 0°, 22.5°, 45°, 67.5°, 90°, 112.5°, 135°, and 157.5°.

In the present embodiment, a pixel unit corresponding to one polarizing unit includes a total of nine pixels each corresponding to the eight polarizing elements 25p to 25w and the non-polarization region 25npa. However, there may be a plurality of pixels corresponding to the non-polarization region 25npa. Furthermore, the number of pixels included in a pixel unit corresponding to one polarizing unit may be the number different from nine.

### Configuration of Controller 10a

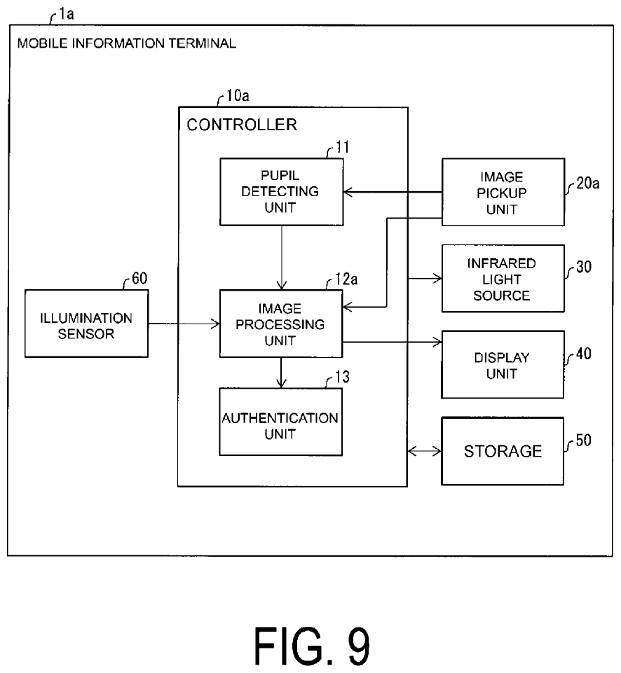

Next, a configuration of a controller 10a provided in the mobile information terminal 1a will be described by using FIG. 9. FIG. 9 is a functional block diagram illustrating a configuration of the mobile information terminal 1a. As illustrated in FIG. 9, the mobile information terminal 1a includes the controller 10a (image processing apparatus), the image pickup unit 20a, an infrared light source 30, a display unit 40, a storage 50, and the illumination sensor 60. The controller 10a includes a pupil detecting unit 11, an image processing unit 12a, and an authentication unit 13.

When illumination detected by the illumination sensor 60 is greater than or equal to a prescribed value, the image processing unit 12a performs image processing on an infrared light image captured with an infrared light image-image pickup region 21a so as to reduce a specularly reflected component contained in infrared light received by the infrared light image-image pickup region 21a. In the present embodiment, the image processing unit 12a determines an output value of a pixel having the lowest received-light intensity of received infrared light (namely, a result obtained through the image processing in the present example) of a plurality of pixels associated with the polarization region 25pa as an output value of the pixel unit. On the other hand, when illumination detected by the illumination sensor 60 is less than the prescribed value, the image processing unit 12a determines an output value of a pixel associated with the non-polarization region 25npa as an output value of the pixel unit.

FIG. 10 is a cross-sectional view schematically illustrating a configuration of the image pickup unit 20a. As illustrated in FIG. 10, reflected light Lr0 becomes reflected light Lr1 having only an infrared light component obtained by removing a visible light component by a visible light blocking filter 26. The reflected light Lr0 is light formed of only diffused reflected light Lr, or the diffused reflected light Lr and specularly reflected light. In the polarization region 25pa, the reflected light Lr1 becomes reflected light Lr2 obtained by further removing light other than light polarized in a specific direction by each of the polarizing elements 25p to 25w (see FIG. 8), and then enters a photodiode 24. Thus, intensity of the reflected light Lr2 is lower than intensity of the reflected light Lr1. On the other hand, in the non-polarization region 25npa, the reflected light Lr1 enters the photodiode 24 while remaining unchanged.

In this way, received-light intensity of infrared light received by the photodiode 24 corresponding to the polarization region 25pa is less than received-light intensity of infrared light received by the photodiode 24 corresponding to the non-polarization region 25npa. Specifically, an attenuation factor by each of the polarizing elements 25p to 25w is generally greater than or equal to 50%. Furthermore, received-light intensity of infrared light is less in low illumination around the mobile information terminal 1a than that in high illumination therearound. This may interfere with the iris authentication in an environment in low surrounding illumination, such as at nighttime or in a dark indoor place, in the image pickup unit 20 (see the first embodiment) including the polarizing elements in all of the pixels of the infrared light image-image pickup region 21a. On the other hand, a reflected image rarely appears in a captured infrared light image in low surrounding illumination.

Thus, when illumination around the mobile information terminal 1a is less than a prescribed value, the image processing unit 12a determines an output value of the photodiode 24 corresponding to the non-polarization region 25npa as an output value of the pixel unit including the photodiode 24. In this way, the mobile information terminal 1a can acquire an infrared light image that enables the iris authentication even in low surrounding illumination.

On the other hand, when surrounding illumination is greater than or equal to the prescribed value, the image processing unit 12a performs the same processing as that in the first embodiment. Thus, the mobile information terminal 1a can perform the image processing on an infrared light image in which an influence of the reflected image Ir is reduced or removed regardless of a surrounding environment.

Therefore, the mobile information terminal 1a can accurately perform the iris authentication processing regardless of a surrounding environment.

Note that a “prescribed value” of illumination herein means the lowest limit of illumination that cannot ignore an influence of the reflected image Ir on the iris authentication.

### Processing of Controller 10a

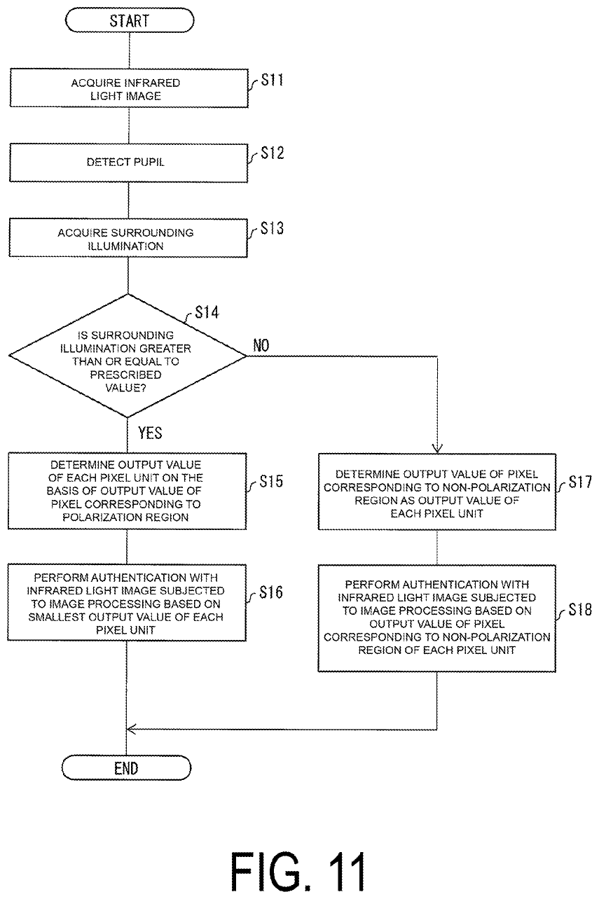

FIG. 11 is a flowchart illustrating iris authentication processing by the controller 10a. In the iris authentication processing by the controller 10a, first, the pupil detecting unit 11 acquires an infrared light image captured with the infrared light image-image pickup region 21a (S11), and then detects a pupil of a user included in the infrared light image (S12). Next, the image processing unit 12a acquires illumination around the mobile information terminal 1a from the illumination sensor 60 (S13), and then determines whether the surrounding illumination is greater than or equal to a prescribed value (S14).

In a case where the surrounding illumination is greater than or equal to the prescribed value (YES in S14), the image processing unit 12a determines an output value of each pixel unit on the basis of an output value of a pixel corresponding to the polarization region 25pa (S15). Subsequently, the authentication unit 13 performs user authentication on the basis of the output value of each pixel unit (S16).

On the other hand, in a case where the surrounding illumination is less than the prescribed value (NO in S14), the image processing unit 12a determines an output value of a pixel corresponding to the non-polarization region 25npa as an output value of each pixel unit (S17). Subsequently, the authentication unit 13 performs user authentication on the basis of the output value of each pixel unit (S18).

Note that the mobile information terminal 1a includes the illumination sensor 60 in the above-mentioned embodiment. However, the mobile information terminal 1a itself does not necessarily include the illumination sensor 60. For example, the mobile information terminal 1a may be configured to receive a signal indicating illumination around the mobile information terminal 1a from an apparatus that includes the illumination sensor 60 different from the mobile information terminal 1a.

Furthermore, the mobile information terminal 1 a may not include the illumination sensor 60 and may estimate illumination with the image pickup unit 20a. Specifically, the controller 10a may measure an output value of a pixel corresponding to the non-polarization region 25npa before capturing an iris image and then estimate surrounding illumination on the basis of the output value. In this case, the controller 10a also functions as an illumination detecting unit that detects surrounding illumination.

### Third Embodiment

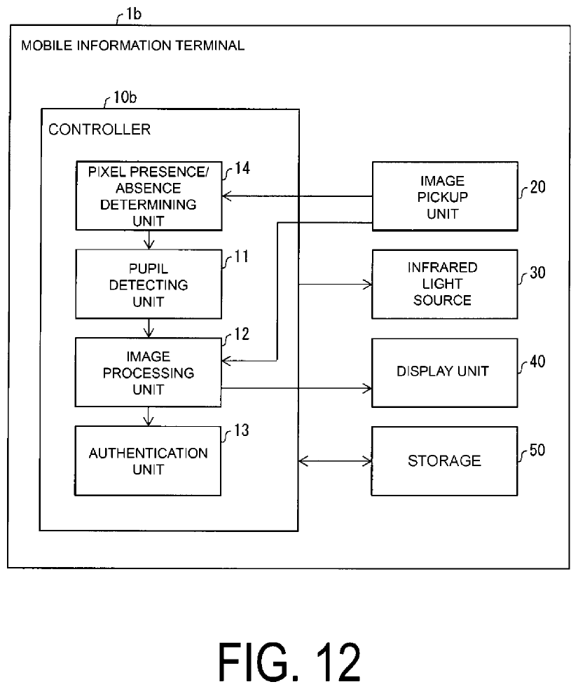

Another embodiment of the present disclosure will be described in the following with reference to FIGS. 12 to 14. Note that, for convenience of a description, components illustrated in respective embodiments are designated by the same reference numerals as those having the same function, and the descriptions of these components will be omitted.

### Configuration of Mobile Information Terminal 1b

A configuration of a mobile information terminal 1b according to the present embodiment will be described by using FIG. 12. FIG. 12 is a functional block diagram illustrating the configuration of the mobile information terminal 1b. As illustrated in FIG. 12, the mobile information terminal 1b is different from the mobile information terminal 1 in that the mobile information terminal 1b includes a controller 10b instead of the controller 10. Specifically, in contrast to the above-mentioned mobile information terminals 1 and 1a, a visible light image captured with a visible light image-image pickup region 21b is also used in addition to an infrared light image captured with an infrared light image-image pickup region 21a in an authentication mode in the mobile information terminal 1b.

### Configuration of Controller 10b

The controller 10b (image processing apparatus) includes a pixel presence/absence determining unit 14 in addition to the configuration of the controller 10. The pixel presence/absence determining unit 14 acquires a visible light image captured with the visible light image-image pickup region 21b and determines whether a pixel that outputs an output value periodically changing is present in a plurality of pixels associated with the visible light image.

When the pixel presence/absence determining unit 14 determines the presence of the pixel that outputs an output value periodically changing, an image processing unit 12 performs image processing on an infrared light image. In other words, in a case of the above-described determination, the image processing unit 12 performs the image processing on the infrared light image captured with the infrared light image-image pickup region 21a so as to reduce a specularly reflected component contained in infrared light received by the infrared light image-image pickup region 21a, as described in the first embodiment. In the present embodiment, the image processing unit 12 determines an output value of a pixel having the lowest received-light intensity of received infrared light (namely, a result obtained through the image processing in the present example) as an output value of the pixel unit for every pixel unit. Then, an authentication unit 13 performs iris authentication on the basis of the output value.

On the other hand, when the pixel presence/absence determining unit 14 determines the absence of the pixel that outputs an output value periodically changing, the image processing unit 12 does not perform the image processing on an infrared light image. In this case, the controller 10b may, for example, cause a display unit 40 to display a selection screen allowing a user to select whether to continue the iris authentication or provide notification of an error indicating that the iris authentication cannot be performed. In the latter case, the controller 10b may release a set authentication mode.

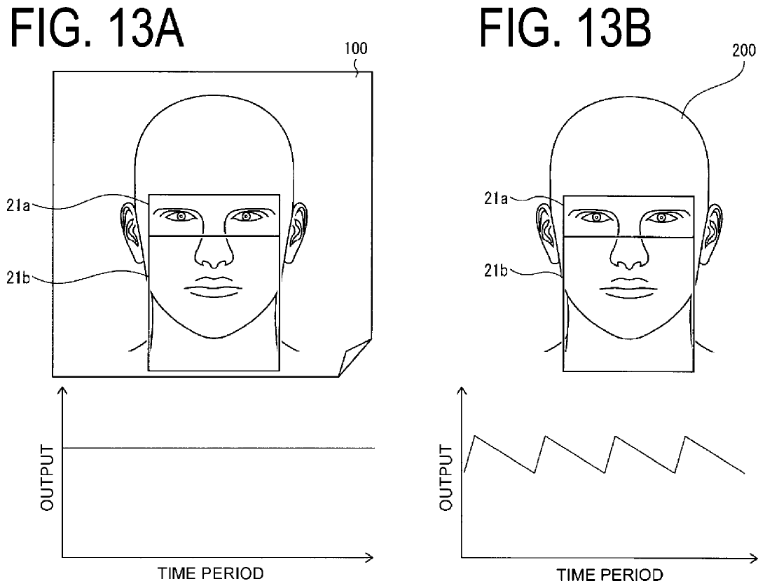

Next, a periodic change in an output value of a pixel will be described with reference to FIGS. 13A and 13B. FIGS. 13A and 13B are diagrams for describing a periodic change in an output value of a pixel. FIG. 13A is a diagram illustrating a piece of paper 100 with an image of a person printed and an output value of a pixel when the paper 100 is continuously captured. FIG. 13B is a diagram illustrating an actual person (user) 200 and an output value of a pixel when the person 200 is continuously captured.

As illustrated in FIGS. 13A and 13B, an image pickup unit 20 captures a region around eyes of an object (a person drawn on the paper 100 or the actual person 200) with the infrared light image-image pickup region 21a and captures a region below the eyes of the object with the visible light image-image pickup region 21b in an authentication mode in the present embodiment.

When iris authentication is performed, an infrared light image needs to keep being captured until pupils are detected from the infrared light image, for example. Thus, capturing by the image pickup unit 20 in the authentication mode also including the above-mentioned embodiments is performed within a prescribed period of time needed for a pupil detecting unit 11 to detect pupils. In the present embodiment, the presence or absence of vital activity in an object is particularly determined as described later, and the determination can be made within the prescribed period of time. The processing of determining the presence or absence of vital activity in an object may be performed at a point of time when alignment for capturing an infrared light image starts before the processing of detecting pupils starts.

Since the paper 100 does not perform vital activity, an output value of a pixel is substantially constant and rarely changes or does not change periodically as illustrated in FIG. 13A when the paper 100 is continuously captured. In contrast, since the actual person 200 performs vital activity, an artery expands and contracts in synchronization with a beat of a heart. Since absorption of light by oxyhemoglobin contained in blood flowing through an artery increases with the artery expanding, received-light intensity of received infrared light decreases. Thus, an output value of a pixel decreases. On the other hand, since absorption of light by oxyhemoglobin decreases with the artery contracting, the above-described received-light intensity increases. Thus, an output value of the pixel increases. Therefore, when a user (person 200) is continuously captured, an output value of the pixel periodically changes in synchronization with a beat of a heart as illustrated in FIG. 13B. Note that a periodic change in an output value of a pixel can be observed at any spot within a region corresponding to a face of a user, and may be observed in a region corresponding to a forehead, a cheek, or the like, for example.

The iris authentication is a personal authentication method having an extremely high degree of reliability. However, when an iris printed on paper with high definition is captured, there is a problem that the iris on the paper may be mistaken for an actual iris and verified. As a solution to this problem, it is effective to detect whether an object is a living body in addition to the iris authentication.

In the present embodiment, as mentioned above, the visible light image-image pickup region 21b of the image pickup unit 20 continuously captures an object, and the pixel presence/absence determining unit 14 determines the presence or absence of a periodic change in an output value of a pixel, thereby detecting whether the object is a living body (for example, the actual person 200). Then, when a periodic change is seen in the output value of the pixel, the controller 10b detects that the object is a living body and performs the iris authentication processing. On the other hand, when a periodic change is not seen in the output value of the pixel, the controller 10b detects that the object is not a living body and does not perform the iris authentication processing. In this way, the controller 10b can exclude an image printed on paper with high definition from the authentication processing. This can prevent unauthorized access by forging an authentication target or the like with paper or the like.

Note that the pixel presence/absence determining unit 14 may be able to determine whether an object is a living body. Specifically, the pixel presence/absence determining unit 14 may be able to determine the presence or absence of a change over time in an output value of a pixel to the extent that an object can be determined to be a living body within a prescribed period of time.

### Processing of Controller 10b

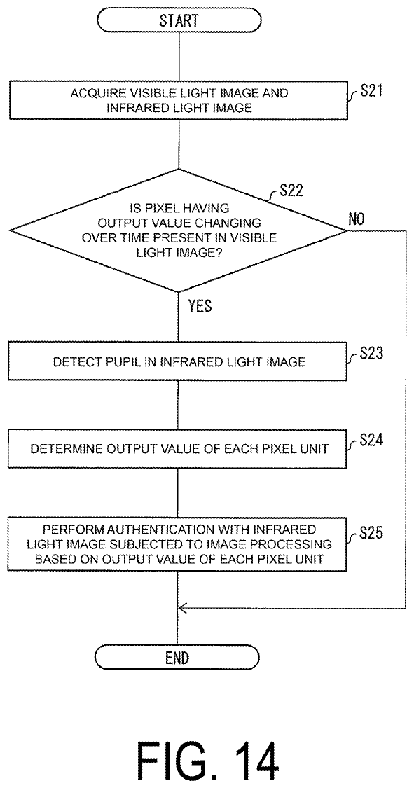

FIG. 14 is a flowchart illustrating iris authentication processing by the controller 10b. In the iris authentication processing by the controller 10b, first, the pixel presence/absence determining unit 14 acquires a visible light image and an infrared light image continuously captured from the image pickup unit 20 (S21), and determines whether a pixel having an output value periodically changing is present in the visible light image (S22). In a case of the presence of the pixel having an output value periodically changing (YES in S22), the pupil detecting unit 11 detects a pupil from the infrared light image (S23), and the image processing unit 12 determines an output value of each pixel unit (S24). Subsequently, the authentication unit 13 performs user authentication with the infrared light image subjected to image processing based on the output value of each pixel unit (S25).

On the other hand, in a case of the absence of the pixel having an output value periodically changing (NO in S22), the processing in the above-mentioned steps S23 to S25 is not performed.

### MODIFIED EXAMPLE

In the above-mentioned embodiment, the pixel presence/absence determining unit 14 determines whether an object is a living body on the basis of a periodic change in an output value of a pixel of a continuously captured visible light image. When the pixel presence/absence determining unit 14 determines that the object is a living body, the controller 10b may further perform face authentication with a visible light image.

The face authentication is an authentication performed by using a feature extracted from a shape and a position of eyes, a nose, a mouth, or the like. In the example illustrated in FIG. 13B, the visible light image captured with the visible light image-image pickup region 21b includes images of a nose and a mouth of the person 200 as the object. Thus, the image processing unit 12 extracts a feature of the nose or the mouth included in the visible light image and the authentication unit 13 analyzes the feature, so that the controller 10b can perform the face authentication.

Note that an image of eyes of the person 200 is included in the infrared light image captured with the visible light image-image pickup region 21b. Thus, the image processing unit 12 extracts a feature of the eyes included in the infrared light image and the authentication unit 13 analyzes the feature of the eyes, so that the controller 10b may perform the face authentication. In this case, the controller 10b can perform the face authentication by using the feature of the eyes, the nose, and the mouth.

Furthermore, a target of the face authentication may be any one of the nose and the mouth included in the visible light image, or may only be the eyes included in the infrared light image. In the latter case, the iris authentication and the face authentication can be performed with only the infrared light image. However, more targets of the face authentication are preferable in consideration of the face authentication performed with high accuracy.

In this way, the controller 10b may perform hybrid authentication by using the iris authentication and the face authentication in combination. Thus, firmer security can be achieved in comparison with the case where only the iris authentication is performed.

### Fourth Embodiment: Implementation Example by Software

The control blocks (in particular, respective units of the controllers 10, 10a, and 10b) of the mobile information terminals 1, 1a, and 1b may be implemented by a logic circuit (hardware) formed in an integrated circuit (IC chip) and the like, or may be implemented by software using a Central Processing Unit (CPU).

In the latter case, the mobile information terminals 1, 1a, and 1b include CPU configured to execute a command of a program, that is software for realizing each function, Read Only Memory (ROM) or a storage device (these are referred to as “recording medium”) configured to store the program and various types of data in a manner capable of being read by a computer (or CPU), Random Access Memory (RAM) to develop the program, and the like. Then, the computer (or CPU) reads the program from the recording medium and executes the program to achieve the object according to one aspect of the present disclosure. As the recording medium, a “non-transitory tangible medium”, such as a tape, a disk, a card, a semiconductor memory, and a programmable logic circuit may be used. Furthermore, the program may be supplied to the computer via any transmission medium (a communication network, a broadcast wave, or the like) able to transmit the program. Note that one aspect of the present disclosure may be implemented in a form of data signal embedded in a carrier wave, which is embodied by electronic transmission of the program.

### Additional Notes

One aspect of the present disclosure is not limited to each of the above-described embodiments. It is possible to make various modifications within the scope of the claims. An embodiment obtained by appropriately combining technical elements each disclosed in different embodiments falls also within the technical scope of one aspect of the present disclosure. Furthermore, technical elements disclosed in the respective embodiments may be combined to provide a new technical feature.

### CROSS-REFERENCE TO RELATED APPLICATION

This application is based upon and claims the benefit of priority from JP 2017-015941, filed on Jan. 31, 2017, the disclosure of which is incorporated herein in its entirety by reference.

### REFERENCE SIGNS LIST

10, 10b Controller (image processing apparatus)
10a Controller (image processing apparatus, illumination detecting unit)
12, 12a Image processing unit
14 Pixel presence/absence determining unit
20, 20a Image pickup unit (image pickup apparatus)
21 Image pickup element
21a Infrared light image-image pickup region
21b Visible light image-image pickup region
25, 25A, 25B, 25C Polarizing filter
25a to 25w Polarizing element
25pa Polarization region
25npa Non-polarization region
26 Visible light blocking filter
32 Infrared light blocking filter
60 Illumination sensor (illumination detecting unit)

1. An image pickup apparatus comprising:
an image pickup element configured to capture an image by a plurality of pixels arranged two-dimensionally,
wherein the image pickup element includes
a visible light image-image pickup region configured to capture a visible light image by receiving visible light, and
an infrared light image-image pickup region configured to capture an infrared light image by receiving infrared light, and
the image pickup apparatus further includes a polarizing filter that includes a plurality of polarizing units including a plurality of polarizing elements having principal axes different from each other, the plurality of polarizing units being associated with the plurality of pixels forming the infrared light image-image pickup region and being arranged two-dimensionally.

2. The image pickup apparatus according to claim 1,
wherein the visible light image-image pickup region and the infrared light image-image pickup region are each formed in the image pickup element.

3. The image pickup apparatus according to claim 1,
wherein an infrared light blocking filter that blocks the infrared light is provided in the visible light image-image pickup region,
a visible light blocking filter that blocks the visible light is provided in the infrared light image-image pickup region, and
a relative position of the infrared light blocking filter to the visible light image-image pickup region and a relative position of the visible light blocking filter to the infrared light image-image pickup region are each fixed.

4. The image pickup apparatus according to claim 1,
wherein each of the polarizing units includes a polarization region in which the polarizing element is present and a non-polarization region in which the polarizing element is not present.

5. An image processing apparatus comprising:
an image processing unit configured to perform image processing on the infrared light image captured with the infrared light image-image pickup region while reducing a specularly reflected component contained in infrared light received by the infrared light image-image pickup region of the image pickup apparatus according to claim 1.

6. An image processing apparatus comprising:
an image processing unit configured to perform image processing on the infrared light image captured by the image pickup apparatus according to claim 4,
wherein the image processing unit
determines, in a case that illumination detected by an illumination detecting unit configured to detect surrounding illumination is greater than or equal to a prescribed value, a result obtained by performing image processing on the infrared light image while reducing a specularly reflected component contained in the infrared light received by the infrared light image-image pickup region as an output value of the plurality of pixels associated with the plurality of polarizing units, and
determines, in a case that illumination detected by the illumination detecting unit is less than the prescribed value, an output value of a pixel of the plurality of pixels associated with the non-polarization region as an output value of the plurality of pixels associated with the plurality of polarizing units.

7. The image processing apparatus according to claim 5,
wherein the image processing unit is configured to determine an output value of a pixel having the lowest received-light intensity of the infrared light received of the plurality of pixels associated with the plurality of polarizing units as an output value of the plurality of pixels.

8. The image processing apparatus according to claim 5 further comprising a pixel presence/absence determining unit configured to determine whether a pixel that outputs an output value changing over time is present in the plurality of pixels associated with the visible light image,
wherein the image processing unit, in a case that the pixel presence/absence determining unit determines that a pixel that outputs an output value changing over time is present, performs image processing on the infrared light image.
